(19) United States
(12) Patent Application Publication
(10) Pub. No.: US 2025/0305634 A1
(43) Pub. Date: Oct. 2, 2025

(54) DOUBLE-WALLED LIQUEFIED GAS STORAGE TANK

(71) Applicant: L'Air Liquide, Societe Anonyme pour l'Etude et l’Exploitation des Procedes Georges Claude, Paris (FR)

(72) Inventors: Guillaume PETITPAS, Jouy-en-Josas (FR); Alexandre MAZEAU, Sassenage (FR)

(21) Appl. No.: 18/863,815

(22) PCT Filed: Apr. 4, 2023
(86) PCT No.: PCT/EP2023/058782

§ 371 Date: Nov. 7, 2024

(30) Foreign Application Priority Data
May 10, 2022 (FR) FR2204410

(51) Int. Cl. F17C 3/00

(52) U.S. Cl. CPC F17C 3/00; F17C 2201/0128; F17C 2203/016; F17C 2203/0329; F17C 2203/0629; F17C 2223/0153

(57) ABSTRACT

The invention relates to a double-walled storage tank for liquefied gas, in particular cryogenic fluid, having an inner wall and an outer wall which is arranged around the inner wall with a thermally insulated gap, wherein the inner wall is suspended in the outer wall at at least one of its ends via a tensioned-cable(s) suspension system between the inner wall and the outer wall, the suspension system having the one same cable passing back and forth more than once between the inner wall and the outer wall via respective guide passages, the cable forming a plurality of connections between the inner wall and the outer wall in different directions, one end of the cable being secured to one of the walls and configured to place the cable under tension.

### CROSS-REFERENCE TO RELATED APPLICATIONS

This application is a § 371 of International PCT Application PCT/EP2023/058782, filed Apr. 4, 2023, which claims § 119(a) foreign priority to French patent application FR 2204410, filed May 10, 2022.

### BACKGROUND

### Field of the Invention

The invention relates to a double-walled tank for storing liquefied gas, in particular cryogenic fluid.

The invention relates more particularly to a double-walled tank for storing liquefied gas, in particular cryogenic fluid, comprising an inner wall delimiting a storage volume for the fluid and an outer wall arranged around the inner wall with a thermally insulated space, wherein the inner wall is suspended in the outer wall at at least one of its ends via a suspension system with one or more cables tensioned between the inner wall and the outer wall.

Cryogenic tanks (for storing, for example, liquefied hydrogen, liquefied nitrogen, liquefied natural gas or the like) generally consist of two walls or shells assembled one inside the other, with an inter-wall space enabling thermal insulation.

This inter-wall space is generally filled with thermally insulating material (foam, multi-layer insulation, etc.) and optionally placed under vacuum.

The fluid is stored in the inner shell. The mechanical connection between the outer shell and the inner shell has to fulfill two roles: limiting thermal inputs via conduction and providing sufficient mechanical strength to react to the various loading scenarios.

The supports or connections have to be dimensioned so as to limit conduction while at the same time being resistant to the loading scenarios. The supports implemented nowadays in trailers transporting cryogenic fluids are generally made from steel, in the form of a neck (sliding or fixed) and tie rods.

These geometries have disadvantages. The use of metal necks leads to inputs of heat that may be substantial, as well as difficulties with assembly (in particular in terms of weld inspections for use with hydrogen).

In order to replace these necks, suspension systems with straps or cables mounted on the dome of the inner shell are known. However, the known solutions are bulky, complex and hamper the installation of thermal insulation between the walls.

### RELATED ART

Documents US 2007068954 and FR1604703 describe other suspension solutions using straps. However, these solutions are complex and unsatisfactory. In particular, each of the straps requires a dedicated mechanism and adjustment of the various straps is complex for centering the inner shell in the outer shell.

### SUMMARY OF THE INVENTION

One aim of the present invention is to overcome all or some of the disadvantages of the prior art that are set out above.

One aim of the invention may thus be to propose a more suitable architecture that minimizes heat transfer, makes it possible to react to the loading scenarios and simplifies manufacturing, avoiding welding if possible.

To this end, the tank according to the invention, which is otherwise in accordance with the generic definition thereof given in the preamble above, is essentially characterized in that the suspension system comprises a single cable that doubles back on itself more than once between the inner wall and the outer wall via respective guide passages, the cable forming a plurality of connections between the inner wall and the outer wall in distinct directions and in that one end of said cable is secured to one of the walls and configured to tension the cable.

Furthermore, embodiments of the invention may have one or more of the following features:
the plurality of connections formed by the cable between the inner wall and the outer wall are located between two respective ends of the inner wall and of the outer wall,
the tank has an overall shape exhibiting symmetry of revolution about a central axis, the connections of the cable between the inner wall and the outer wall are arranged around said central axis and in a plane substantially perpendicular to this central axis,
the guide passages for guiding the cable at the inner and outer walls are formed by rings or orifices borne respectively by the inner and outer walls,
the guide passages for guiding the cable are borne by a plate and/or a hoop secured to one end of the wall in question,
the two ends of the cable are fixed to a single positionally adjustable connecting point,
the connecting point is able to move in a determined direction and is acted upon by a return member such as a spring for tensioning the cable,
the tank has a mechanism for adjusting the tension exerted by the return member on the cable,
the tank has a cylindrical overall shape with a circular section and extending in a longitudinal direction,
the tank is of the horizontal type, i.e. the longitudinal direction is horizontal in the use configuration of the tank,
the cable is composed of at least one of the following materials: polymer, polymer and/or composite fiber(s), Kevlar, epoxy, carbon, glass fibers.

The invention may also relate to any alternative device or method comprising any combination of the features above or below within the scope of the claims.

Other particular features and advantages will become apparent from reading the following description, which is provided with reference to the figures, in which:

### BRIEF DESCRIPTION OF THE FIGURES

The invention will be better understood upon reading the following description, which is given solely by way of example and with reference to the appended drawings, in which:

FIG. 1 is a schematic and partial view in longitudinal and vertical section of one example of a tank according to one possible embodiment of the invention,

FIG. 2 is a schematic and transparent perspective view of one end of a tank according to another embodiment of the invention,

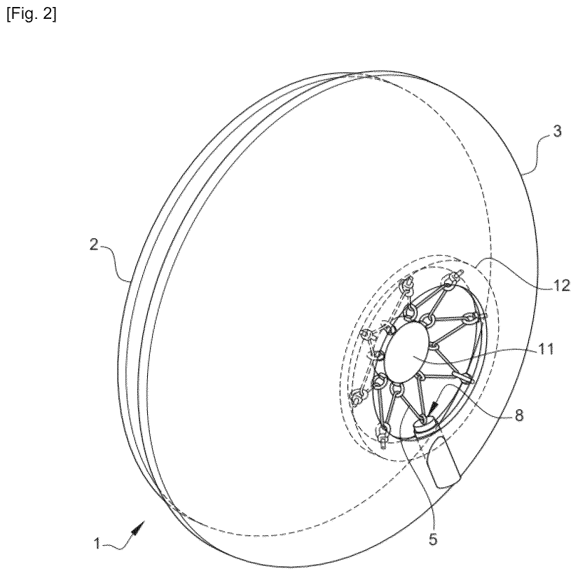

FIG. 3 is a schematic perspective view of a detail from FIG. 2,

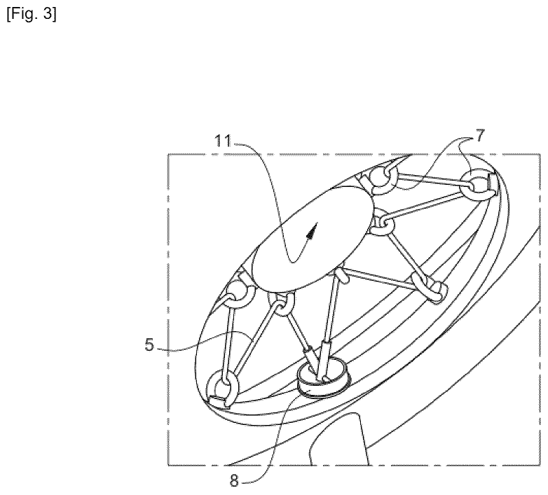

FIG. 4 is a sectional view of a detail from FIG. 3,

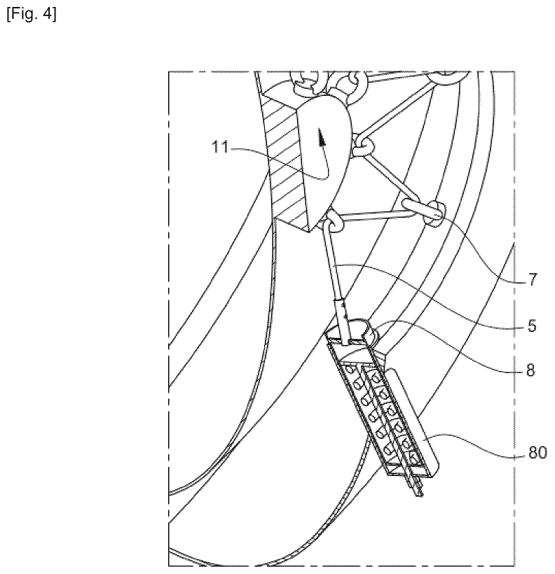

FIG. 5 is a sectional view of an enlarged detail from FIG. 4.

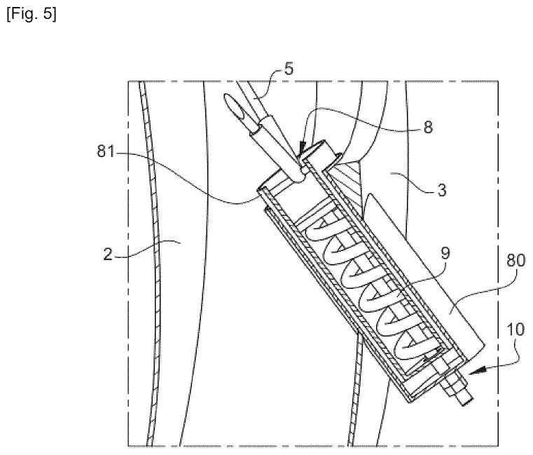

### DETAILED DESCRIPTION OF THE INVENTION

The illustrated double-walled tank 1 for storing liquefied gas comprises an inner wall 2 or shell delimiting a sealed storage volume for the fluid and an outer wall 3 or shell arranged around the inner wall with a space 4 between these two walls 2, 3. This space is thermally insulated, for example via one or more layers of thermally insulating material. If necessary, this space is under vacuum.

The inner wall 2 is suspended in the outer wall 3 at at least one of its ends, for example a longitudinal end, via a suspension system with one or more cables tensioned between the inner wall 2 and the outer wall 3, said suspension system being described in more detail below.

The other end (opposite end) of the inner wall 2 is preferably also suspended in the outer wall 3 via a single suspension system with one or more cables tensioned between the inner wall 2 and the outer wall 3. However, the other end may be suspended via another connecting structure, for example a fixed or sliding neck, a set of tie rods, etc.

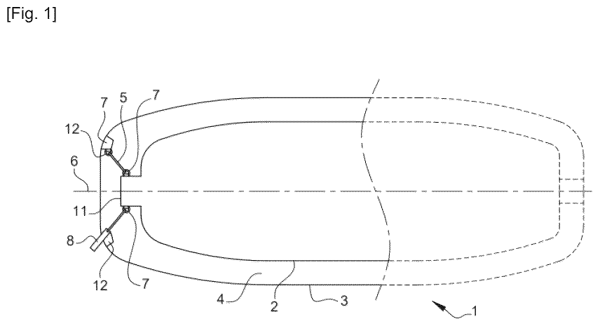

As illustrated, the tank 1 may have a cylindrical overall shape with a circular section and extending in a longitudinal direction. The tank has, for example, an overall shape exhibiting symmetry of revolution about a central axis 6. In addition, the tank 1 is preferably of the horizontal type, i.e. the longitudinal direction is horizontal in the use configuration of the tank as illustrated in FIG. 1 (horizontal central axis 6).

The illustrated suspension system comprises a single cable 5 that doubles back on itself more than once between the inner wall 2 and the outer wall 3 via respective guide passages 7 at the inner wall 2 and the outer wall 3. This means that the cable 5 defines at least three portions tensioned between the inner wall 2 and the outer wall 3, the cable 5 passing through at least two guide passages that enable a change of direction (return from one wall to the other). This forms a plurality of tensile connections between the inner wall 2 and the outer wall 3 in distinct directions with a single cable.

In addition, at least one end of the cable 3 is secured to one of the walls 3 and configured to tension the cable 5 in each of its portions forming a connection between the inner wall 2 and the outer wall 3.

Thus, the two walls 2, 3 are easily centered with respect to one another and the tension of the cable can be adjusted at a single location for all of the connections providing tensile forces in different directions around the central axis 6.

The plurality of connections formed by the cable 5 between the inner wall 2 and the outer wall 3 are preferably located between two respective ends of the inner wall 2 and of the outer wall 3. This means that this connecting system is installed at the neck of the tank, adjacent to the tops of the ends of the two walls 2, 3 (between the outer face of the inner wall 2 and the inner face of the outer wall 3).

As illustrated, the connections of the cable 5 between the inner wall 2 and the outer wall 3 are preferably arranged around the longitudinal central axis and in a plane substantially perpendicular to this central axis 6.

As illustrated, the cable may form a plurality of connections in a star configuration over 360 degrees about this central axis 6.

As illustrated, the two ends of the cable 3 may be fixed to a single positionally adjustable connecting point 8. These two ends of the cable 5 may be connected together at a determined location and configured to make it possible to adjust, optionally with a return member 9, the tension in this cable and therefore to adjust both the axial and longitudinal relative position of the two walls 2, 3. For example, the device has a mechanism 10 for adjusting the tension exerted by the return member 9 on the cable 5.

For example, at least one of the ends of the cable 5 is fixed to a support, the position of which may be adjustable by screwing, for example a shaft or an internal sleeve that can move within a fixed external sleeve 80, the position of the shaft or of the internal sleeve with respect to the fixed external sleeve 80 is adjustable via a mechanical system, for example with a nut 10.

In the examples illustrated, the guide passages 7 for guiding the cable at the inner 2 and outer 3 walls are formed by loops or eyes fixed respectively by the inner 2 and outer 3 walls (preferably fixed on a support that is itself fixed to the wall 2, 3 in question).

For example, and as illustrated, the guide passages 7 for guiding the cable 5 are defined by rings or eyes fixed respectively by a plate 11 secured to an outer end of the inner wall 2 and on a hoop 12 or plate secured to an inner end of the outer wall 3.

The rings may thus be fixed by screw-fastening, welding or the like.

Of course, this embodiment is not limiting, thus, all or some of the loops could be replaced by simple passage orifices formed in the plate 11 or hoop 11 enabling the cable 5 to pass through and be guided.

The cable 5 is composed, for example, of at least one of the following materials: polymer, polymer fiber(s) and/or composite fibers, carbon Kevlar, epoxy, glass fibers, etc. This type of polymer/composite fiber is very resistant (high Young's modulus and fracture resistance) and has low thermal conductivity.

Thus, at at least one end, a single cable 5 and a single system for adjusting its tension may be provided in order to ensure the suspension (and adjustment thereof) of the inner wall 2 in the outer wall 3.

The suspension system is compact, has low thermal conductivity, is mechanically solid and is easier to manufacture than the known solutions (little or no welding, easy access, minimal interaction with the inter-wall insulation). This solution is particularly suitable for on-board solutions (transported mobile tanks) with a small volume (approximately 1 m³) for which bulk and thermal performance are critical (typically for liquid hydrogen). Claims

[symbol]

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-12. (canceled)

13. A double-walled tank for storing liquefied gas, comprising an inner wall delimiting a storage volume for the fluid and an outer wall arranged around the inner wall with a thermally insulated space,
Wherein the inner wall comprises at least one end, and wherein the outer wall comprises at least one end,
wherein the inner wall is suspended in the outer wall at at least one of the ends via a suspension system with one or more cables tensioned between the inner wall and the outer wall,
wherein the suspension system comprises a single cable that doubles back on itself more than once between the inner wall and the outer wall via respective guide passages, the cable forming a plurality of connections between the inner wall and the outer wall in distinct directions and in that one end of said cable is secured to one of the walls and configured to tension the cable.

14. The tank as claimed in claim 13, wherein the plurality of connections formed by the cable between the inner wall and the outer wall are located between two respective ends of the inner wall and of the outer wall.

15. The tank as claimed in claim 13, wherein the tank has an overall shape exhibiting symmetry of revolution about a central axis and in that the connections of the cable between the inner wall and the outer wall are arranged around said central axis and in a plane substantially perpendicular to this central axis.

16. The tank as claimed in claim 13, wherein the guide passages for guiding the cable at the inner and outer walls are formed by rings or orifices borne respectively by the inner and outer walls.

17. The tank as claimed in claim 16, wherein the guide passages for guiding the cable are borne by a plate and/or a hoop secured to one end of the wall in question.

18. The tank as claimed in claim 13, wherein the two ends of the cable are fixed to a single positionally adjustable connecting point.

19. The tank as claimed in claim 18, wherein the connecting point is able to move in a determined direction and is acted upon by a return member such as a spring for tensioning the cable.

20. The tank as claimed in claim 19, further comprising a mechanism for adjusting the tension exerted by the return member on the cable.

21. The tank as claimed in claim 13, wherein the tank has a cylindrical overall shape with a circular section and extending in a longitudinal direction.

22. The tank as claimed in claim 21, wherein the tank is of the horizontal type, wherein the longitudinal direction is horizontal in the use configuration of the tank.

23. The tank as claimed in claim 13, wherein the cable is composed of at least one of the following materials: polymer, polymer and/or composite fiber(s), Kevlar, epoxy, carbon, and glass fibers.

24. The tank as claimed in claim 13, further comprising a cable suspension system at just one end or at each of two distinct ends of the tank.
